(19) United States
(12) Patent Application Publication
(10) Pub. No.: US 2025/0131212 A1
(43) Pub. Date: Apr. 24, 2025

(54) LARGE LANGUAGE MODEL AUGMENTATION WITH KNOWLEDGE LANGUAGE MODELS

(71) Applicant: SRI International, Menlo Park, CA (US)

(72) Inventors: Pengfei Yu, Princeton, NJ (US); Yi Yao, Princeton, NJ (US); Karan Sikka, Robbinsville, NJ (US); Michael A. Cogswell, Yardley, PA (US); Ajay Divakaran, Monmouth Junction, NJ (US)

(21) Appl. No.: 18/919,630

(22) Filed: Oct. 18, 2024

Related U.S. Application Data
(60) Provisional application No. 63/591,903, filed on Oct. 20, 2023.

(51) Int. Cl. G06F 40/56

(52) U.S. Cl. CPC G06F 40/56

(57) ABSTRACT

In an example, a method for generating responses by a Machine Learning (ML) system includes processing, by a first language model, a natural language instruction to generate an instruction representation based on a meaning of the natural language instruction; translating, by a translation module comprising an interface between the first language model and a second language model, the instruction representation into data indicating an intent of the natural language instruction, wherein the second language model is trained with domain specific knowledge; providing, by the translation module, the natural language instruction and the data indicating the intent of the natural language instruction to the second language model; and generating, by the second language model, a response based on the natural language instruction and the data indicating the intent of the natural language instruction.

This application claims the benefit of U.S. Patent Application 63/591,903, filed Oct. 20, 2023, which is incorporated by reference herein in its entirety.

### GOVERNMENT RIGHTS

This invention was made with Government support under contract number W911NF-22-C-0048 awarded by the Army Research Office. The Government has certain rights in the invention.

### TECHNICAL FIELD

This disclosure is related to machine learning systems, and more specifically to large language model augmentation with knowledge language models.

### BACKGROUND

While large language models (LLMs) have capability to generate human-quality text and answer questions across a wide range of topics, LLMs often struggle with specific domain knowledge. The gap in domain expertise is due to the limitations of the training data LLMs are exposed to, which may not cover all nuances of a particular field. Existing approaches to address the gap in domain expertise is fine-tuning, which involves training the LLM on a dataset specific to the desired domain. The fine-tuning process can be computationally expensive and time-consuming, especially for very large models. Additionally, if the domain changes or new information becomes available, the LLM model may need to be retrained, further increasing the cost and inflexibility.

### SUMMARY

Traditional approaches for augmenting LLMs with domain-specific knowledge typically involve fine-tuning the entire LLM on a domain-specific dataset. Traditional approaches can be computationally expensive and time-consuming, especially for very large models. In general, techniques are described that overcome the limitations of traditional fine-tuning by disentangling the tasks of instruction following and domain knowledge acquisition. In other words, the LLM may be trained to follow instructions separately from the ability of the LLM to acquire and understand domain-specific information. By training a smaller language model on domain-specific knowledge, the overall computational cost and training time may be significantly reduced compared to fine-tuning a very large LLM.

In accordance with the disclosed techniques, when working with a new domain, only the smaller language model may be retrained. The pre-trained LLM by contrast may in some cases remain unchanged, without retraining to accommodate the new domain, thereby providing a stable foundation for various applications. In some cases, the LLM is trained with fewer training cycles or less training data than would otherwise be required to accommodate the new domain.

The disclosed techniques may incorporate pre-training of an LLM on a massive amount of text data, enabling the model to understand and generate human-quality text. A smaller language model may be trained on a dataset specific to the desired domain. The smaller language model may thereby acquire the necessary domain knowledge. The smaller language model may be a knowledge language model.

A machine learning system implementing the disclosed techniques may combine the LLM and the smaller language model trained on domain-specific knowledge. In some examples, the machine learning system combines the two models using a translation module that may allow the machine learning system to transform the hidden representation of the LLM into a format that is more suitable for the input space of a smaller domain-specific model. In this way, the machine learning system augments the LLM with the smaller language model. As described herein, by combining the strengths of both models, the augmented LLM may provide more accurate and informative responses, especially in domains where the smaller model has specialized knowledge. When working with new domains, the smaller model may be quickly retrained, allowing the LLM to adapt to changing requirements for the new domains without the need for extensive fine-tuning. The disclosed techniques may be more computationally efficient than traditional fine-tuning, making these techniques suitable for a wider range of applications.

The techniques may provide one or more technical advantages that realize at least one practical application. For example, the disclosed techniques may provide the ability to quickly train and fine-tune the smaller model, which may allow for rapid deployment of an LLM augmented with such a smaller model in new domains. Such improvement in the technical field of generative artificial intelligence (AI), in particular, to generative AI tasks that require domain-specific knowledge may be achieved by combining the strengths of the pre-trained LLM and the smaller domain-specific model. In some cases, the disclosed techniques may offer a significant reduction in computational complexity compared to fine-tuning very large LLMs.

In an example, a method for generating responses by a Machine Learning (ML) system includes: processing, by a first language model, a natural language instruction to generate an instruction representation based on a meaning of the natural language instruction; translating, by a translation module comprising an interface between the first language model and a second language model, the instruction representation into data indicating an intent of the natural language instruction, wherein the second language model is trained with domain specific knowledge; providing, by the translation module, the natural language instruction and the data indicating the intent of the natural language instruction to the second language model; and generating, by the second language model, a response based on the natural language instruction and the data indicating the intent of the natural language instruction.

In an example, a computing system for generating responses by a Machine Learning (ML) system includes: processing circuitry in communication with storage media, the processing circuitry configured to execute a machine learning system comprising a first language model, a second language model and a translation module, the machine learning system configured to: process, by the first language model, a natural language instruction to generate an instruction representation based on a meaning of the natural language instruction; translate, by the translation module comprising an interface between the first language model and the second language model, the instruction representation into data indicating an intent of the natural language instruction, wherein the second language model is trained with domain specific knowledge; provide, by the translation module, the natural language instruction and the data indicating the intent of the natural language instruction to the second language model; and generate, by the second language model, a response based on the natural language instruction and the data indicating the intent of the natural language instruction.

In an example, non-transitory computer-readable storage media has instructions encoded thereon, the instructions configured to cause processing circuitry to: process, by a first language model, a natural language instruction to generate an instruction representation based on a meaning of the natural language instruction; translate, by a translation module comprising an interface between the first language model and a second language model, the instruction representation into data indicating an intent of the natural language instruction, wherein the second language model is trained with domain specific knowledge; provide, by the translation module, the natural language instruction and the data indicating the intent of the natural language instruction to the second language model; and generate, by the second language model, a response based on the natural language instruction and the data indicating the intent of the natural language instruction.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating an example computing environment for augmenting an LLM with a knowledge language model, in accordance with one or more techniques of the disclosure.

FIG. 2 is a detailed block diagram illustrating an example computing system, in accordance with the techniques of the disclosure.

FIG. 3 shows graphs illustrating the challenge of Smaller Language Models (SLMs) with respect to instruction understanding, in accordance with the techniques of this disclosure.

FIG. 4 is a diagram illustrating an example of domain specific finetuning, in accordance with the techniques of the disclosure.

FIG. 5 is a detailed block diagram illustrating an example framework for augmenting LLMs with knowledge language models, in accordance with the techniques of the disclosure.

FIG. 6 shows graphs illustrating valuation performance of LLM that has been augmented in accordance with the techniques of the disclosure.

FIG. 7 is a flowchart illustrating an example mode of operation for a machine learning system, according to techniques described in this disclosure.

Like reference characters refer to like elements throughout the figures and description.

### DETAILED DESCRIPTION

Large language models (LLMs), even those trained on vast amounts of text data, may need specific adaptation to be effective in particular domains or for long-term tasks. LLMs are typically trained on diverse text data, but LLMs may lack in-depth knowledge of specific domains like medicine, law, or science. To excel in these areas, LLMs may require additional training on domain-specific data or fine-tuning to understand the nuances of the language used within those fields. LLMs have a limited ability to remember and process information over extended periods of time. This limited ability may be problematic for tasks that require long-term context, such as answering questions about historical events or following complex narratives. Additionally, to improve long-term memory of such models, LLMs may need to be augmented with external memory systems or trained on data that emphasizes temporal relationships.

In one non-limiting example, a Machine Learning (ML) system that includes an augmented LLM may be asked to write a function (programming code) that determines if there are two numbers in a list that are closer than a certain threshold.

In one example, a first model (small model) may have 350 million parameters. The first model may be specifically trained for this task, making it a “specialist.” Even though the first model may be smaller, this model may be very efficient at this particular task.

A second model (large model) may have 40 billion parameters. The second model may be a “generalist” model trained on a vast amount of data. While the second model may potentially perform many tasks, the second model may not be as efficient or accurate for this specific function compared to the smaller model. The first model, trained specifically for the code generation task, may better understand the programming language concepts than the second model, for the focused training has improved performance of the first model on this specific problem.

The smaller model size of the first model may require less computational power to run, making the first model faster and more resource friendly. The second model may potentially handle a wider range of tasks beyond this specific code generation task. However, the second model may not be as accurate or efficient for this particular problem compared to the first, specialized model.

Fine-tuning a smaller domain-specific model may therefore be a more effective technique in some circumstances. The smaller, 350 million parameter model, trained specifically for code generation in the above example illustrates the benefits of specialization. The smaller model can be trained using additional data relevant to the domain. This training may help the smaller model learn the specific nuances and vocabulary used in that domain. Smaller models may require less computational power and training time.

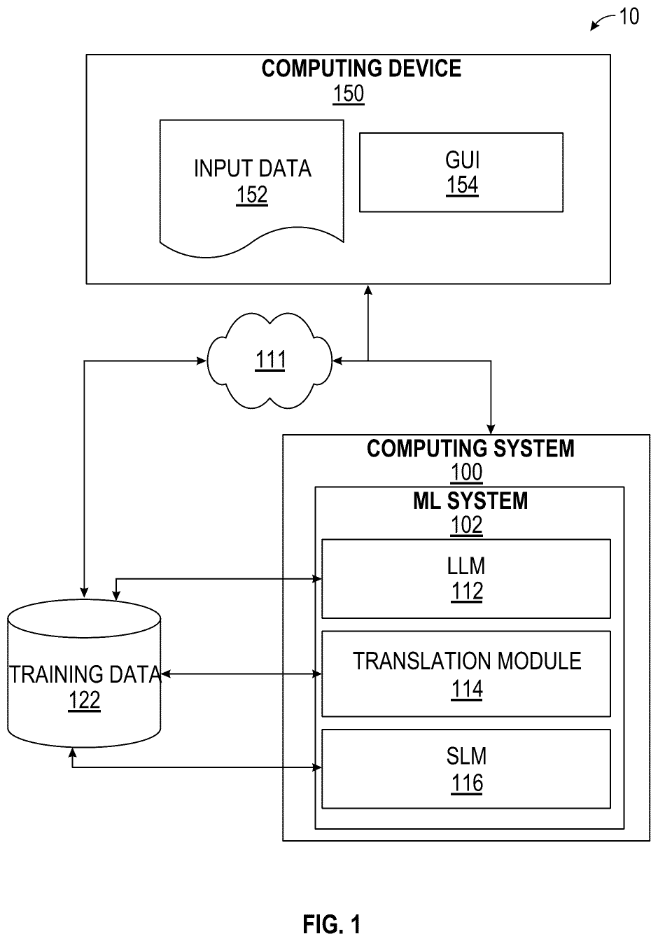

FIG. 1 is a block diagram illustrating an example computing environment for LLM augmentation with a knowledge language model, in accordance with one or more techniques of the disclosure. Computing environment 10 includes computing system 100, computing device 150, training data 122, and network 111. Computing device 150 may include a mobile computing device, such as a mobile phone (including a smartphone), a laptop or desktop computer, a virtual assistant, a voice assistant, a smart home device, a smart speaker, a smart display, smart watch, a smart television or set-top box or video/audio streaming device, a tablet computer, a wearable computing device, or any other computing device. In the example of FIG. 1, computing device 150 stores input data 152 and graphical user interface (GUI) 154. Input data 152 may represent audio data, text data (e.g., string data structures), or other types of data representing an utterance, speech, text, or other type of statement created or otherwise input by a user associated with computing device 150. Input data 152 may include textual data. For example, input data 152 may include human-written instructions describing desired code functionalities (referred to hereinafter as a “user desired function). Such instructions may be used by computing system 100 to generate corresponding code. For example, input data 152 may represent audio data captured using a microphone of computing device 150 and/or audio data received by computing device 150 (e.g., via a tele-conferencing application). Input data 152 may be transcribed from such audio data. In another example, input 152 may represent text data generated via user inputs associated with GUI 154 and/or text data received by computing device 150 (e.g., via a messaging application).

GUI 154 may include a user interface associated with functionality of computing device 150. For example, GUI 154 of FIG. 1 may be a user interface for a software application associated with a Machine Learning (ML) system, such as ML system 102. Although illustrated in FIG. 1 as internal to computing device 150, GUI 154 may generate output for display on an external display device. In some examples, GUI 154 may provide an option for a user of computing device 150 to input data 152, such as textual data (prompt/query/instructions). GUI 154 may provide an option for a user of computing device 150 to input data 152 to ML system 102, which may output textual descriptions, answers to queries, or generated code based on text included in input data 152. Although described as a graphical user interface, GUI 154 may represent any type of interface by which a user of computing device 150 can perform operations attributed herein to GUI 154, such as a command line interface, a website or form, or some combination thereof.

Although illustrated as external to computing system 100, computing device 150 may be a component of computing system 100. Computing device 150 and computing system 100 may communicate via communication channel 111, which may include a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, or other types of communication channels for transmitting data between computing systems, servers, and computing devices. Alternatively, or in addition, although not shown, computing system 100 may receive input data 152 from a storage device that interfaces with computing system 100 and that stores input data 152. Such storage devices may include a USB drive, a disk drive (e.g., solid state drive or hard drive), an optical disc, or other storage device or media.

Computing system 100 may represent one or more computing devices configured to execute ML system 102, which may include LLM 112, translation module 114, and domain-specific Smaller Language Model (SLM) 116. LLM 112 may include computer-readable instructions for understanding and processing textual information. For example, LLM 112 may be trained on massive datasets of text, allowing LLM 112 to learn patterns, grammar, and semantics. Domain-specific SLM 116 augmenting LLM 112 may offer a more practical solution to some tasks, as compared to large-scale LLMs. LLM 112 may be a generic model that is a trained on a general dataset.

LLM 112 may include computer-readable instructions for understanding and generating human language, referred to hereinafter as “natural language.” LLM 112 may be trained on billions or even trillions of words, making LLM 112 very powerful. LLM 116 may be trained to generate a response to a query inputted by a user. ML system 102 may provide data generated by LLM 112 (e.g., hidden representation described below) to a trained translation module 114. The translation module 114 may act as a bridge between LLM 116 and the domain-specific SLM 116.

Training data 122 represents a storage device configured to store training data for one or more of LLM 112, translation module 114, or SLM 116. Training data 122 is an important component of the system, serving as a repository for the information used to train the various models. This data may be essential for the models to learn and improve their performance. In some examples, training data 122 stores high-quality human instructions alongside code examples, as described below. The high-quality human instructions may include carefully curated examples of tasks or prompts that humans would provide to LLM 112. The code examples may include specific instances of code that correspond to the human instructions. In an aspect, LLM 112 may use training data 112 to learn how to determine meaning of the human instructions, as described below. SLM 116 may use training data 112 to learn how to perform specific tasks or understand complex concepts. For example, if training data 112 contains instructions related to image recognition, SLM 112 may learn to identify objects or patterns in images. It should be noted that while, in some examples, translation module 112 may not directly receive training data 122, translation module 112 may benefit indirectly from training data 122 used to train LLM 112 and SLM 116. For example, the understanding of language and context of LLM 112 may enhance the ability of translation module 114 to accurately translate natural language instructions into data indicating an intent of the natural language instructions, as described below.

Generally, smaller models require less computational power for training and inference. In other words, SLM 116 may be trained more quickly and deployed on less powerful hardware. Lower computational requirements may translate to lower costs, both in terms of hardware and energy consumption. While larger models might require more resources, they often exhibit better performance on complex tasks, especially those involving generation of creative text.

GUI 154 is a user interface that may be associated with functionality of computing device 150. For example, GUI 154 of FIG. 1 may be a user interface for a software application associated with a messaging application, a social media application, a word processing application, a tele-conferencing application, a video or audio streaming application, or the like. Computing device 150 may store input data 152 as audio data or text data input by a user interacting with GUI 154. For example, in instances where GUI 154 includes a user interface associated with a messaging application, computing device 150 may store input data 152 as user inputs associated with an electronic keyboard or external keyboard of computing device 150. In another example, in instances where GUI 154 includes a user interface associated with a tele-conferencing application, computing device 150 may store input data 152 as audio data associated with an utterance captured using a microphone of computing device 150. In some examples, computing device 150 may store input data 152 as text data by applying speech-to-text techniques to convert audio data captured using the microphone of computing device 150 to text data. In other examples, where input data 152 includes text data, computing device 150 may apply text-to-speech techniques to convert the text data of input data 152 to audio data prior to providing input data 152 to machine learning system 110. Although illustrated in FIG. 1 as internal to computing device 150, GUI 154 may generate output for display on an external display device. Although illustrated as external to computing system 100, computing device 150 may be a component of computing system 100. Computing device 150 may not include a GUI in all examples of computing device 150. For example, a voice assistant device implementation implements a voice interface to receive audio data as user input for input data 152. In some instances, computing device 150 may retrieve, via network 111, at least a portion of input data 152 (e.g., instructions) from external sources such as the Internet.

Computing device 150 may send, via network 111, input data 152 to computing system 100. Computing system 100 may receive input data 152 from computing device 150. Input data 152 may define a query, such as request for information or a request to perform a task. In some cases, the task is to generate computer code based on input data 152.

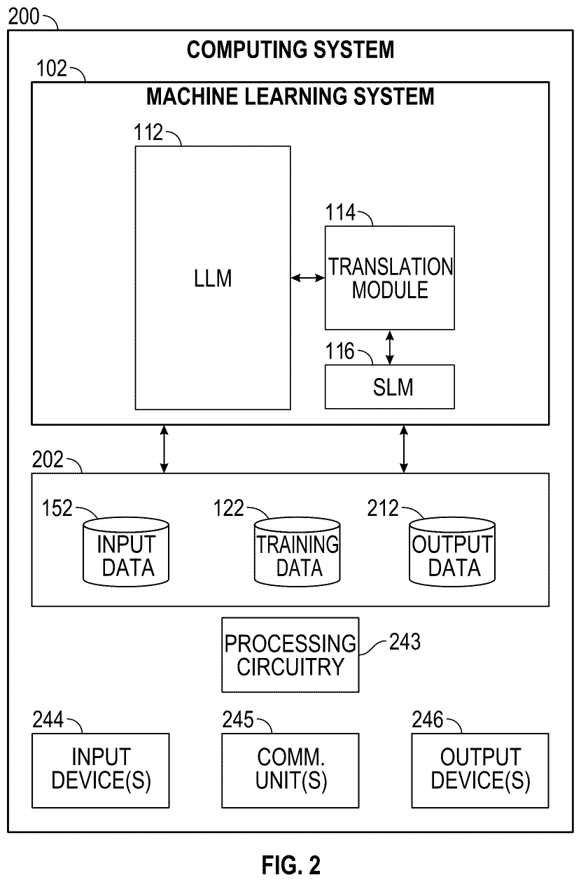

In accordance with the techniques described herein, computing system 100 may perform analysis of input data 152. In one example, SLM 116 may be trained on a computer programming domain, i.e., coding domain. The variety of tasks in this domain makes it rich, but the nature of code makes the domain distinct from other domains which primarily involve natural languages. Computing system 100 may process input data 152 to generate a response to the instructions inputted by a user. Computing system 100 may generate code corresponding to human-written instructions describing a user desired function, as described below in conjunction with FIG. 2.

In an example, directly fine-tuning SLM 116 on a specific domain may yield significant improvements in overall system performance. In contrast to LLM 112 that may be a generic model trained on a general dataset, SLM 116 may be a domain specific model, relatively small (in terms of a number of parameters) in comparison to LLM 112, and fine-tuned on limited domain data. The vast knowledge base of LLM 112 may be augmented with a knowledge base of the specific domain of SLM 116, enabling LLM 116 to understand and generate text/responses more accurately when provided data from SLM 116 in accordance with techniques described herein. LLM 112 may lack the capacity to capture the intricacies of a specific domain. While SLM 116 may require less training data 122 overall, SLM 116 may need a domain-specific data to achieve optimal performance. Smaller models are more efficient but may have limitations in performance for complex tasks. Larger models, such as LLM 112, potentially provide better performance but may require more resources. The disclosed ML system 102 combines benefits of both types of models to provide an overall improvement in both performance and accuracy.

While generally larger models often exhibit better performance on complex tasks, such better performance may not be a guarantee. The quality of the training data 122, the training methodology, and the specific task at hand may also play significant roles. Smaller, specialized models may sometimes outperform larger models on specific tasks, especially when they are tailored to a particular domain. Training larger models may require more computational resources, including powerful hardware (like GPUs) and significant energy consumption. Accordingly, training of LLM 112 may translate to higher costs.

In summary, FIG. 1 illustrates machine learning system 102, specifically involving LLM 112 and SLM 116 trained with domain-specific knowledge. LLM 112 may analyze the instruction to determine its meaning, considering the context and nuances of the language. LLM 112 may create a structured representation (e.g., a hidden representation discussed in greater detail below) of the instruction (in other words, an “instruction representation”), capturing the essential meaning and intent of the instruction. The translation module 114 comprising an interface between LLM 112 and SLM 116 may translate the instruction representation into data that indicates the intent of the original instruction. The translation module 114 may send both the original natural language instruction and the translated intent data to SLM 116. SLM 116, equipped with domain-specific knowledge, may process the instruction and intent data to generate a relevant and informative response.

In essence, this method combines the strengths of a large language model for understanding natural language with the domain expertise of a smaller language model to produce tailored and accurate responses. By leveraging both models, the ML system 102 may effectively handle a variety of tasks and provide informative answers to user queries.

FIG. 2 is a block diagram illustrating an example computing system 200. In an aspect, computing system 200 may represent computing system 100 shown in FIG. 1. LLMs are capable of understanding and generating text information, making LLMs valuable for a wide range of applications. However, larger language models may require more resources for training and inference (i.e., generating text or completing tasks). Such additional resources may impact the cost of deploying and using the LLMs. To address the aforementioned limitations, as shown, computing system 200 includes processing circuitry 243 and memory 202 for executing a machine learning system 102 having a LLM 112, translation module 114 and domain-specific SLM 116. The LLM 112 may include any one or more of various types of LLMs, such as, but not limited to, transformer-based LLMs, Recurrent Neural Network (RNN)-based LLMs, multi-modal LLMs and the like.

Computing system 200 may be implemented as any suitable computing system, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 200 may represent a cloud computing system, a server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster. In some examples, at least a portion of system 200 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. Processing circuitry 243 of computing system 200 may implement functionality and/or execute instructions associated with computing system 200. Computing system 200 may use processing circuitry 243 to perform operations in accordance with one or more aspects of the present disclosure using software, hardware, firmware, or a mixture of hardware, software, and firmware residing in and/or executing at computing system 200. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Memory 202 may comprise one or more storage devices. One or more components of computing system 200 (e.g., processing circuitry 243, memory 202) may be interconnected to enable inter-component communications (physically, communicatively, and/or operatively). In some examples, such connectivity may be provided by a system bus, a network connection, an inter-process communication data structure, local area network, wide area network, or any other method for communicating data. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules described in accordance with one or more aspects of this disclosure.

Processing circuitry 243 and memory 202 may provide an operating environment or platform for one or more modules or units (e.g., LLM 112, translation module 114, SLM model 116), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute machine learning system 102 using virtualization modules, such as a virtual machine or container executing on underlying hardware. One or more of such modules may execute as one or more services of an operating system or computing platform. Aspects of machine learning system 102 may execute as one or more executable programs at an application layer of a computing platform.

One or more input devices 244 of computing system 200 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 may include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

In the example of FIG. 2, machine learning system 102 may receive input data from an input data set 152 and may generate output data 212. Input data 152 and output data 212 may contain various types of information, which will generally be tailored to the application/use case for the LLMs. When used in the example system of FIG. 1, input data 152 may include, for example, instruction tokens. Other types of input data 152 may include various types of text including, for example, a prompt related to a previously generated code. Output data 212 may include information such as, but not limited to, a generated token.

Machine learning system 102 may process training data 122 to train one or more of LLM 112, translation module 114, and SLM 116, in accordance with techniques described herein. For example, a pretraining stage may involve training LLM 112 on a massive amount of text data. The goal of the pretraining stage may be for LLM 112 to learn general representations of language and vision. As other examples, training data 122 may come in the form of billions or even trillions of words, making the process of training LLM 112 of ML system 102 intensive and the resulting trained LLM 112 very powerful. During training, SLM 116 may be trained on domain-specific data, making SLM 116 more adept at generating responses that are relevant and accurate within that domain.

As noted above, as the model size increases, the training process requires significantly more iterations and computations. More iterations may lead to training times that span days, weeks, or even months, depending on the model and hardware used. Long training times may slow down the development process. It may take longer to experiment with different model architectures, hyperparameters, or training data configurations. Training LLM 112 requires powerful hardware, typically GPUs or TPUs. Powerful resources may be expensive to acquire and maintain. Training LLM 112 may also consume a significant amount of energy to power the hardware. Energy consumption may translate to electricity costs that may be substantial for large models. Training on cloud platforms may also incur costs based on the resources used (computing hours, storage).

Smaller models, due to their smaller size, may require fewer computations and training iterations. Fewer computations may lead to significantly faster training times, which may be completed in hours or even minutes depending on the model complexity. The computational demands of smaller models may be less, resulting in lower costs for hardware, energy consumption, or cloud resources. There is often a trade-off between model size and cost. While larger models may potentially achieve better performance, the training time and financial costs may be significant. Smaller models offer faster and more cost-effective training, but performance of the smaller models may be lower. In one non-limiting example, if high performance is important, a larger model may be worth the cost. If resources are limited, a smaller model may be more practical.

As noted above, larger models have the potential to learn more complex patterns and perform better on specific tasks. However, as mentioned earlier, large models may have limitations in their capacity for domain-specific tasks. In the example illustrated in FIG. 2, LLM 112 may be trained on vast amounts of general data, which may not include the nuances and vocabulary specific to a particular domain like code generation, for example. LLM 112 may be designed and trained to be versatile across various tasks. This versatility may come at the expense of in-depth knowledge in any single domain. In one non-limiting example, SLM model 116 may have been specifically trained on code-related data, even though SLM 116 is smaller than LLM 112. The code generation task may be less complex, allowing a smaller model with focused training to achieve good performance.

In essence, while LLM 112 has the potential for better performance, such better performance is not always a guarantee. Domain-specific training and task complexity play an important role in determining the effectiveness of a model. Currently, fine-tuning existing models is a common approach. However, training a large model may take significant time and resources. The computational power needed may be expensive.

The architecture illustrated in FIG. 2 may provide efficient ways to augment LLM 112 for specific domains, allowing LLM 112 to achieve good performance without the drawbacks mentioned above.

In accordance with the disclosed techniques, machine learning system 102 utilizes SLM model 116 already trained on relevant domain data (if available) as well as translation module 114 that may learn to bridge the gap between the understanding of the general LLM 112 and the desired domain of SLM 116 (e.g., code generation). Unlike traditional LLMs, SLM 116 may leverage existing domain knowledge.

Advantageously, a framework for domain-specific fine-tuning that is illustrated in FIG. 2 may leverage the strengths of both techniques. SLM 116 may provide faster training times, lower resource requirements. LLM 112 may capture complex patterns and nuances. The combined techniques of FIG. 2 may achieve good domain-specific performance with a smaller model, reducing training time and resource requirements. Machine learning system 102 may leverage knowledge from LLM 112 through translation module 114, potentially boosting performance compared to just using a small model (e.g., SLM 116). Machine learning system 102 may potentially be applied to various domain-specific tasks by adapting the training data 122 and fine-tuning process.

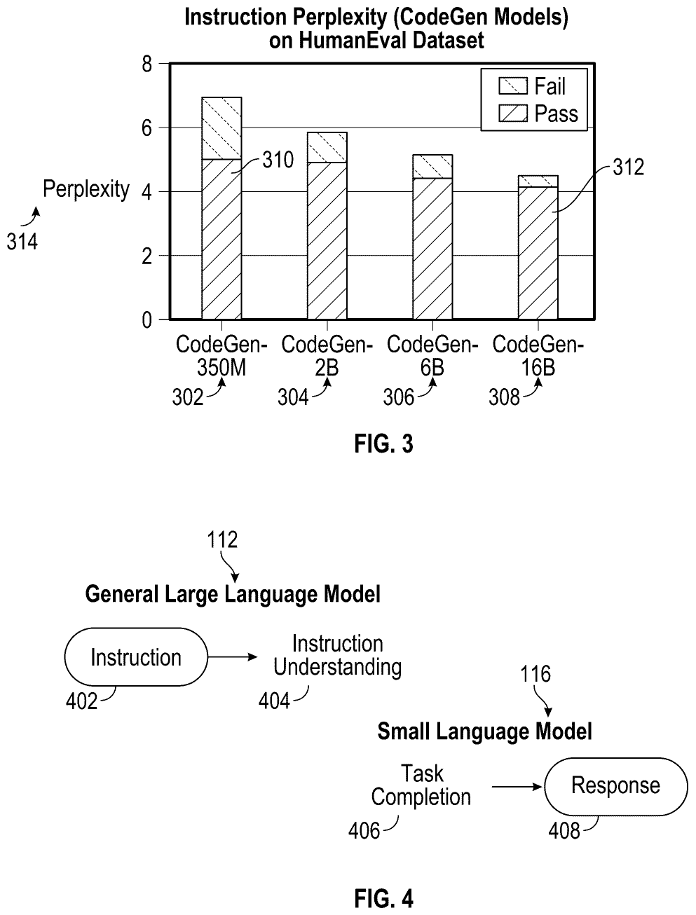

FIG. 3 shows graphs illustrating challenges of Smaller Language Models (SLMs) with respect to instruction understanding, in accordance with the techniques of this disclosure. Perplexity 314 measures how well a language model predicts the next token (word, character) in a token sequence.

Lower perplexity 314 indicates a better understanding of the probability of the token sequence. In the context of code generation, the token sequence may represent lines of code, keywords, or specific function calls. Perplexity 314 in FIG. 3 may be the perplexity of human-written instructions describing a user desired function (e.g., desired code functionalities). FIG. 3 shows results of an experiment with different CodeGen models. In the example of FIG. 3, first CodeGen model 302 has 350 million parameters, second CodeGen model 304 has 2 billion parameters, third CodeGen model 306 has 6 billion parameters and fourth CodeGen model 308 has 16 billion parameters.

According to the techniques disclosed herein, the CodeGen models 302-308 may have been specifically trained on code-related data, making the CodeGen models suitable for understanding the specifics of code generation within a particular domain. FIG. 3 further illustrates a “pass rate” metric for each of the models 302-308 that may calculate the percentage of problems where the generated code of the model successfully passes all given test cases. The test cases may provide an objective measure of the correctness and functionality of the generated code. In the illustrated example, lower pass rate suggests higher perplexity score, which in turn suggests that a particular model may struggle to understand the complexity and nuances of human-written instructions.

In the context of FIG. 3, the first CodeGen model 302, having only 350 million parameters, is considered an SLM model. FIG. 3 illustrates that the first CodeGen model 302 has the lowest pass rate 310. In other words, the first CodeGen model 302 (referred to hereinafter as SLM 302) may have difficulty predicting the specific code sequences that would fulfill the desired functionalities described in the instructions. SLM 302 may have been trained on datasets lacking the specific vocabulary and structure used in human instructions. The training may have heavily focused on code syntax learning, neglecting the ability to comprehend natural language descriptions. As a result, SLM 302 may struggle to grasp the overall context and purpose of the instructions, making it difficult to generate relevant code.

As mentioned above, perplexity 314 may reflect how well a language model grasps the sequence of tokens (words or characters) in a natural language instruction. A lower perplexity score may indicate better understanding of the probability of the instruction and how the tokens relate to each other. When a code generation attempt with a specific instruction fails, such failure may often correlate with a higher perplexity score for that instruction. The higher perplexity score may suggest the model encountered difficulties in processing the instruction accurately.

FIG. 3 also illustrates a general trend of higher perplexity scores for smaller models on the instruction dataset. SLM 302 is the smallest model and has the lowest pass rate, while fourth CodeGen model 308 is the largest model and has the highest pass rate 312. FIG. 3 highlights a key challenge: smaller models may not have the capacity or training to understand the complexities and nuances present in human-written instructions. SLM 302 may be trained on code-specific data sets lacking the richness of natural language used in human instructions.

SLM 302 may not be exposed to the diverse vocabulary and grammar structures present in instruction descriptions. The training may have primarily focused on learning code syntax rules and structure. While learning code may be important, SLM 302 may neglect the development of natural language processing skills necessary to determine meaning and intent in instructions.

SLM 302 may struggle with connecting different parts of an instruction, grasping overall context of the instruction, and understanding the user desired function. Such struggles may make it difficult for SLM 302 to generate relevant and purposeful code based on the instruction.

The disclosed techniques address the limitations of SLMs and LLMs discussed above, and provide code generation models that can effectively process natural language instructions and can effectively generate code based on the processed instructions.

As discussed earlier, ML system 102 may achieve good performance for code generation within a specific domain while maintaining efficiency (training time, resource usage). In one example, SLM 116 may be trained specifically on code generation data relevant to the domain. SLM 116 may be efficient for focused tasks where a complexity of LLM 112 may not be necessary. In one example, SLM 116 may be a pre-trained code generation model (if available) as a starting point. SLM 116 may be further fine-tuned on domain-specific code and instruction data to leverage existing knowledge.

In other words, SLM 116 that is used as augmentation to LLM 112 may require less computational resources. Training on domain-specific data may help SLM learn the relevant vocabulary and concepts. As discussed earlier, SLM 116 may struggle with complex natural language instructions.

While focusing on an efficiency of SLM 116, during code generation, ML system 102 may address limited instruction understanding of SLM 116 by employing the pre-trained LLM 112 to process the natural language instructions.

In other words, the disclosed techniques may combine the understanding of instructions from LLM 112 with the domain-specific knowledge of SLM 116 for code generation. In an example, the smaller domain-specific SLM model may focus on generating code relevant to the domain.

FIG. 4 is a diagram illustrating an example of domain specific finetuning, in accordance with the techniques of the disclosure. Advantageously, as used in the disclosed techniques, SLM 116 may focus on learning the specific code functionalities and vocabulary relevant to a particular domain. As discussed earlier, training of SLM 116 may be computationally efficient due to smaller size of SLM 116.

In accordance with the disclosed techniques, ML system 102 may utilize a general-domain pre-trained LLM 112 to process natural language instructions 402 to determine a meaning of instructions 402. In one example, ML system 102 may extract the hidden representation from this LLM 112 that may capture the key information and meaning of the instructions. As used herein, the term “hidden representation” refers to internal activations, also known as hidden states or representations, comprising the outputs of neurons within the layers of the neural network of LLM 112. These activations are not directly visible to the outside world but play an important role in understanding and processing of the input data by LLM 112. The internal activations may encode understanding 404 of input instruction 402 by LLM 112. By extracting the hidden representation, ML system 102 may capture the interpretation of the meaning of the instruction 402 by LLM 112, focusing on the relevant aspects. In one non-limiting example, LLM 112 may extract the hidden representation by directly accessing the outputs of specific layers within LLM 112. The pre-trained LLM 112 may take natural language instruction 402 as input and may generate a hidden representation.

In one non-limiting example, ML system 102 may use the hidden representation extracted from LLM 112 as input to the smaller domain-specific model (SLM 116) responsible for task completion 406 (e.g., code generation). By combining the hidden representation and the code/template, SLM model 116 may leverage the understanding 404 of instruction 402 of LLM 112 to generate domain-specific code that fulfills the desired functionality. The “instruction understanding” refers to data indicative of meaning determined by LLM 112 from instruction 402. Advantageously, domain-specific SLM model 116 may be efficient to train and use. The capabilities of LLM 112 may contribute to better comprehension of complex instructions 402. SLM 116 may provide a response 408 (e.g., generated code).

By passing the hidden representation extracted from the pre-trained LLM 112 as additional input features to domain-specific SLM model 116, ML system 102 may essentially inject the understanding 404 of instruction 402 of LLM 112 into the task completion (e.g., code generation) process. This additional information may provide SLM 116 with richer context beyond the raw text of instruction 402. The hidden representation may capture the interpretation of the meaning and key points of the instruction 402 determined by LLM 112. The hidden representation generated by LLM 112 may reside in a high-dimensional space optimized for internal functionality of LLM 112. In one example, ML system 102 may utilize translation module 114 that may allow ML system 102 to transform the hidden representation into a format that may be more suitable for the input space of domain-specific SLM 116.

In one non-limiting example, translation module 114 may act as an adapter, ensuring the information from LLM 112 may be represented in a way SLM 116 can effectively utilize for code generation. By combining the hidden representation of LLM 112 and the translation module 114, ML system 102 may improve the benefit of the instruction understanding 404 of LLM 112 for the smaller SLM model 116. The additional information may enrich the context for SLM 116, enabling SLM 116 to understand complex instructions 402 within the domain despite having, for instance, a lower number of parameters that would otherwise result in perplexity. The SLM model 116 may remain efficient for training and running, making the overall solution scalable.

SLM 116 may have lower latency because SLM 116 may have fewer parameters to process, resulting in quicker calculations. SLM 116 may be trained on domain-specific data, making SLM 116 more adept at generating a response, e.g., code that is relevant and accurate within that domain.

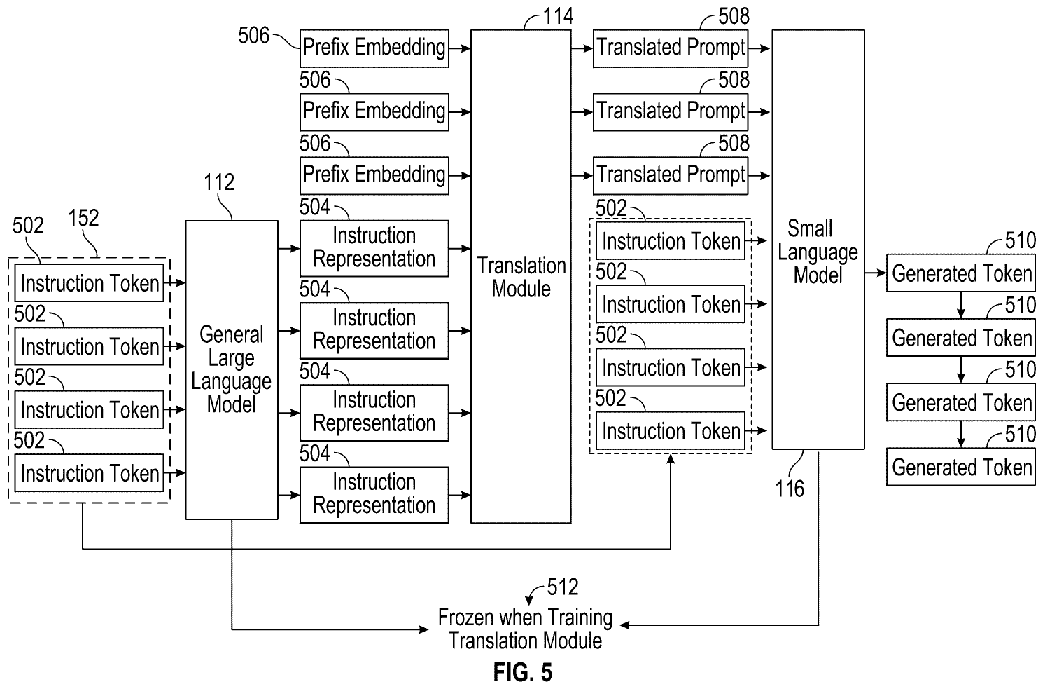

FIG. 5 is a detailed block diagram illustrating an example framework for augmenting an LLM with a knowledge language model, in accordance with the techniques of the disclosure. As shown in FIG. 5, LLM 112 may process the input instructions 402 that may be represented as a sequence of instruction tokens 502 and may generate hidden representations 504, capturing the key information and meaning of the instructions 402. In an aspect, ML system 102 may employ a prefix-tuning technique. The prefix-tuning is a technique used to adapt pre-trained models to specific tasks without requiring extensive fine-tuning on new data. This technique may involve adding a small number of learnable parameters (prefix embeddings) to the beginning of the input sequence. It should be noted that fixed-length prefix embeddings 506 may be pre-defined embeddings that may provide additional context or guidance to the translation module 114.

According to the techniques of the present disclosure, in one example, the translation module 114 may comprise a machine learning model. The machine learning model may be trained to translate the hidden representations 504 of the instructions 402 and prefix embeddings 506 into soft prompts 508, as described in further detail below. In some examples, the machine learning model is a transformer network and may have a number of layers, e.g., 4 layers. Transformer networks process input data sequentially, but these models may also weigh the importance of different parts of the input simultaneously using an attention mechanism. The attention mechanism allows the transformer networks to capture long-range dependencies in data. In other examples, the machine learning model may be implemented as a Recurrent Neural Network (RNN) or a state space model. RNNs process input data sequentially, maintaining a hidden state that stores information about the previous inputs. The hidden state allows the RNNs to capture temporal dependencies in data. State space models represent a system as a set of equations that describe how the state of the system evolves over time. The state space models are often used to model physical systems or complex processes. The choice of the machine learning model may depend on the specific characteristics of the data. Soft prompts 508 are a variation of prefix-tuning where the prefix embeddings are not fixed but rather learned during the training process. Soft prompts 508 may provide more flexibility and adaptability in guiding the output of SLM 116. Soft prompts 508 are learned parameters, while fixed-length prefix embeddings 506 are pre-defined.

The domain-specific SLM 116 may generate the final response 408. In one example, the response 408 may include a sequence of generated tokens 510.

In an example, the process flow may start with LLM 112 processing original instructions 402. The disclosed techniques may further involve LLM 112 generating hidden representations 504 for instruction tokens 502. ML system 102 may concatenate and/or add the fixed-length prefix embeddings 506 with hidden representations 504. ML system 102 may pass concatenated/added embeddings 506 through translation module 114 to generate soft prompts 508.

In this way, translation module 114 translates embeddings that capture an understanding of natural language instructions into embeddings that the domain specific model can use to generate a response that is pertinent to the domain. Translation module 114 obtains output tokens 502 from the LLM 112 that represent the instruction along with learned prefix embeddings 506 as input. It then outputs new embeddings (corresponding to the prefixes), which are fed as part of the input to SLM 116.

To that end, ML system 102 may prepend the soft prompts 508 to the original instructions 502. The combined input (original instruction tokens 502 with new embeddings-soft prompts 508) may be fed by the ML system 102 to the domain-specific SLM 116 to generate a response, e.g., to generate code. In an example, the general domain LLM 112 may provide valuable insights into the instructions 402, enhancing the understanding of SLM 116.

As shown in FIG. 5, the soft prompts 508 generated by the translation module 114 may act as additional context, guiding SLM 116 towards more relevant response generation, e.g., code generation. The domain-specific SLM model 116 may be more computationally efficient for the domain, e.g., code generation, as compared to LLM 112.

In one example, during training of the translation module 114, both LLM 112 and the domain specific SLM 116 may be frozen 512. In another example, only LLM 112 may be frozen, while the translation module 114 and SLM 116 are trained. By freezing the larger model (LLM 112), ML system 102 may ensure that the translation module 114 learns to map between the hidden representations 504 of LLM 112 and the desired soft prompts 508 without altering the internal parameters of LLM 112. This freeze 512 may allow the translation module 114 to focus solely on the task of generating appropriate soft prompts 508.

In addition, freezing 512 the LLM 112 may prevent the knowledge of LLM 112 from being overwritten or diluted during the training of the translation module 114. This freeze 512 may ensure that the understanding 404 of the instructions 402 by LLM 112 may be preserved.

To effectively train the translation module 114, the ML system 102 may need a suitable dataset that captures the relationship between the hidden representations 504 from LLM 112 and the desired soft prompts 508.

Ideally, ML system 102 may need a dataset containing pairs of the natural language instructions and the corresponding responses. In one implementation, these pairs should represent various instructions 402 and their intended meanings.

The training dataset should include a diverse range of instructions, covering different complexities, domains, and styles. Such diversity may ensure that the translation module 114 can generalize well to unseen instructions 402. The quality of the soft prompts 508 in the training data set may be important as well. The soft prompts 508 should accurately reflect the desired meaning and intent of the instructions 402, guiding SLM 116 towards relevant responses, e.g., code generation. In one example, the training dataset may be created by manually annotating hidden representations 504 from LLM 112 with corresponding soft prompts 508. Manually annotated training data 112 may comprise high-quality data but can be time-consuming. In one non-limiting example, techniques like generative models or rule-based systems may automatically generate pairs of the natural language instructions and the corresponding responses. While the aforementioned techniques may be faster, the quality may not be as good as manually annotated training data 112.

ML system 102 may explore existing datasets or benchmarks in the field of natural language processing or code generation that may contain relevant data or inspiration. Additionally, in accordance with the disclosed techniques, ML system 102 may normalize the hidden representations 504 and soft prompts 508 to a consistent scale. ML system 102 may tokenize the soft prompts 508 for compatibility with the input format of SLM 116.

In a non-limiting example, ML system 102 may use a domain-specific dataset like the “code operator” dataset for training the translation module 114. According to the disclosed techniques, the “code operator” dataset may specifically focus on the coding domain, aligning well with the described above case of generating code from instructions. In an example, the “code operator” dataset may contain pairs of instructions (similar to prompts) and corresponding code responses (similar to desired behaviors). This structure may provide the necessary parallel data for training the translation module 114.

The “code operator” dataset may focus on code operators, which are fundamental building blocks in code. In one example, by training on this data, the translation module 114 may learn to translate LLM hidden representations 504 into soft prompts 508 that capture the specific operations and structures needed for code generation. The translation module 114 may learn to generate soft prompts 508 that are more relevant and nuanced for code generation tasks within the specific domain.

Domain-specific training on the “code operator” dataset may lead to better performance in translating LLM hidden representations 504 into meaningful soft prompts 508 for the domain-specific SLM model 116. It should be noted, while the “code operator” dataset may focus on operators, the dataset may still capture broader relationships between instructions and code functionalities, improving generalizability to various coding tasks.

In one example, the “code operator” dataset may contain approximately 20,000 instruction-response pairs related to coding. If domain specific evaluation benchmark (human eval) is Python-specific, for example, the ML system 102 may filter the training data 122 to include only instructions and responses relevant to Python language. Focusing on Python may ensure that the translation module 114 is trained on data that aligns closely with the target domain.

In this example, the translation module 114 may learn to map between LLM hidden representations 504 and soft prompts 508 that are more relevant to Python code generation.

The disclosed techniques may allow for a smaller dataset that can be processed more efficiently, especially for training the translation module 114. In the illustrated example, using a Python-focused dataset may ensure that the training of the translation module 114 may align well with the evaluation metrics used in the human eval benchmark.

According to the disclosed techniques, including instructions 402 explicitly mentioning “Python” in the text may be a straightforward way to identify potentially relevant examples. In an aspect, selecting instructions 402 where the corresponding response 408 (desired behavior) is identified as Python code may ensure the instruction 402 directly relates to code generation within the target domain. In this example, by focusing on instructions 402 with explicit references to Python or Python code responses, ML system 102 may create a training dataset highly relevant to the task of generating Python code from instructions 402.

During training, the translation module 114 may learn from a training dataset focused on Python commands and functionalities, leading to more accurate soft prompt 508 generation for code generation. Furthermore, ML system 102 may use a Python-specific dataset that aligns well with the human evaluation benchmark (focused on Python code), ensuring that the translation module 114 may be trained and evaluated on the same domain.

In one non-limiting example, the evaluation benchmark may offer a diverse set of 164 coding challenges, providing a comprehensive evaluation. Each coding problem may be presented as instruction 402. In an example, the instruction-based format may align well with the disclosed techniques of using natural language instructions for code generation.

The instructions 402 may provide clear information about the input format and expected behavior of the user desired function. In one non-limiting example, the instructions 402 may comprise the following: “write a function that calculates the factorial of a given non-negative integer.” In this example, the natural language instruction specifies the user desired function (calculate factorial), input (non-negative integer), and expected output (factorial of the input). In this example, SLM 116 may generate the programming code that implements the logic of the user desired function using a recursive algorithm.

This disclosed techniques may help evaluate how well the ML system 102 can understand and translate instructions into functional code.

The aforementioned benchmark may directly assess the ability of the ML system 102 to generate code based on human-written instructions, making the benchmark highly relevant to the aforementioned task.

As noted above, the benchmark may include 164 coding problems. These problems may cover a wide range of coding tasks, ensuring a thorough evaluation of the capabilities of the disclosed ML system 102.

The comprehensive “human eval” aspect of the assessment process means that human experts may evaluate the generated code, providing a more reliable assessment of quality and correctness.

Each problem included in the benchmark may come with a set of test cases to assess the correctness and functionality of the generated code. The performance assessment may utilize a “pass rate” metric (discussed above in conjunction with FIG. 3) that may calculate the percentage of problems where the generated code of the SLM model 116 successfully passes all the given test cases. The test cases may provide an objective measure of the correctness and functionality of the generated code. As noted above, by evaluating against multiple test cases, an evaluator may assess the ability of the ML system 102 to handle various scenarios and edge cases. For performance comparison, the Code Gen family of models may be used. As discussed above, the Code Gen model family may include models specifically trained on code-related data. As used herein, the term “foundation models” refers to the models that are trained on a broad range of data, including code. The versatility of foundation models may also be beneficial for code generation, as this versatility may allow the model to leverage knowledge from various domains. The pass rate based on test cases may be a clear and relevant metric for code generation tasks. The Code Gen model family may offer a range of options for assessment, including, but not limited to, code-specific and foundation models, allowing the evaluator to select the most suitable one based on needs and available resources.

In one example, a performance assessment may include a version of the CodeGen model family pre-trained on a massive dataset of 6 billion emails. This large dataset may allow the language model to learn general language understanding capabilities.

In this example, the performance assessment may further include two additional CodeGen models, one with 350 million parameters and another with 2 billion parameters.

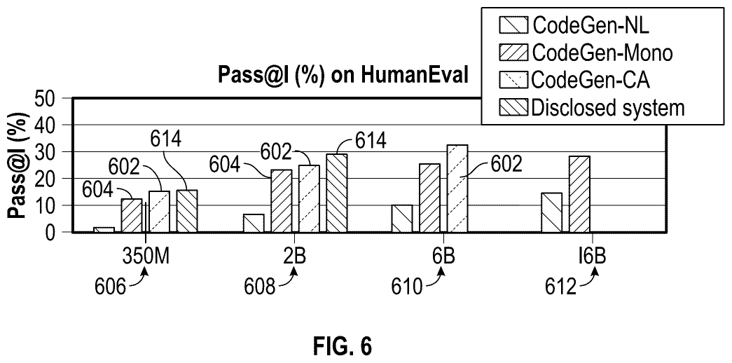

As part of the assessment, at least some of the CodeGen models may have been specifically trained on code-related data (denoted CodeGen-CA in FIG. 6), making the CodeGen models suitable for understanding the specifics of code generation within a particular domain.

In this case, by comparing the performance of 350 million parameter and 2 billion parameter CodeGen models may allow the evaluator to assess the impact of the SLM model size on the effectiveness of the translation module 114 and overall code generation quality.

Fine-tuning the translation module 114 on a code-related dataset may introduce additional code knowledge and patterns that would not necessarily be present in the baseline CodeGen models. Such fine-tuning may raise a valid concern about fairness in the comparison.

More specifically, the baseline CodeGen models (350 million and 2 billion parameter versions) may be fine-tuned on the same code-related dataset used for the translation module. This fine-tuning would equip the baseline models with similar code knowledge, creating a more level playing field.

In one example, an evaluator may create a new set of CodeGen models, denoted by “CA” in FIG. 6, which may be specifically fine-tuned on a code-related dataset called “code alpaca.” This fine-tuning may ensure that both the disclosed ML system 102 (with the translation module 114) and the baseline CodeGen models (CodeGen CA) have similar exposure to code knowledge. By fine-tuning all SLM models on the same code data, an evaluator may create a more balanced comparison. The performance differences observed may primarily reflect the effectiveness of the translation module 11 4 and not an inherent knowledge advantage.

FIG. 6 shows graphs illustrating valuation performance of the augmented LLM, in accordance with the techniques of the disclosure. FIG. 6 illustrates that fine-tuning the CodeGen CA models 602 may lead to better performance on code generation tasks compared to the un-tuned models 604 (e.g., 350 million and 2 billion parameter versions).

It should be noted that fine-tuning the CodeGen CA models 602 and freezing the SLM model 166 of the ML system 102 during translation module training may be well-suited techniques to address the knowledge gap and ensure a fair evaluation of the disclosed techniques.

With respect to model sizes in the illustrated example, the size of the SLM could be either a 350 million parameter model 606 or a 2 billion parameter model 608. In this example, the size of the LLM may be either a 6 billion parameter model 610 or a 16 billion parameter model 612. The SLM models implemented as CodeGen models may be baseline models that are from the Code Gen family, represented by bars 604 in FIG. 6. The Code Gen CA models represented by bars 602 may be fine-tuned on the “code alpaca” dataset for a fair comparison.

It should be noted that to assess the impact of scale on performance, a range of model sizes can be experimented with. The smaller models may be specifically trained on domain-specific code data.

FIG. 6 presents the results of an example experiment comparing different approaches for code generation from natural language instructions.

Bars 614 represent the results achieved by the ML system 102, which includes the translation module 114. As noted above, bars 602 represent the results of the baseline approach, using the fine-tuned CodeGen CA models (350 million and 2 billion parameter versions).

As discussed previously, fine-tuning the CodeGen CA models on the code alpaca dataset may address the concern about imbalanced knowledge compared to directly using un-tuned CodeGen models. This fine-tuning may introduce some level of code knowledge into the baseline, making the comparison more fair and representative of the actual impact of the translation module 114 in the disclosed techniques.

The results illustrated in FIG. 6 indicate that the ML system 102 having 2 billion parameter SLM model 116 combined with the translation module 114 (represented by bar 614) has surpassed the performance of the 2 billion CodeGen CA model alone (represented by bar 602). In this context, LLM 112 provides a strong foundation in general language understanding. This understanding enables LLM 112 to effectively process and interpret the instructions. The translation module 114 may act as a bridge, transferring the understanding of the instructions of LLM 112 into a format that the SLM model (e.g., 2 billion parameter model) can utilize.

The disclosed techniques implemented by the ML system 102 having the translation module 114 significantly improve the performance of the 2 billion parameter model 608. At the same time, for the 350 million parameter model 606, the results shown in FIG. 6 suggest that incorporating the translation module 114 may not offer a significant improvement. One possible explanation is that the 350 million parameter SLM model 116 may have a lower capacity to effectively utilize the additional information provided by the translation module 114. This size of the SLM model 116 could be less capable of handling the complexity of the hidden representations 504 of LLM 112. The translation module 114 may require more training data 122 or more sophisticated training techniques to be effective with smaller SLM models 116, like the 350 million parameters one.

Based on the observed results shown in FIG. 6, one of the hypothesis might be that the 350 million parameter SLM model 116 is primarily limited by the coding knowledge rather than instruction understanding ability. Smaller models often have limitations in their capacity to learn complex patterns and relationships. In an aspect, while the translation module 114 may have improved instruction understanding, the 350 million parameter SLM model 116 may still lack the coding knowledge to generate accurate and complete responses, as described above.

It should be noted when comparing the performance of the ML system 102 implementing disclosed techniques (2 billion parameters SLM model) with a 6 billion parameter 610 Code Gen CA model 602, the ML system 102 may have slightly lower performance, potentially due to the factors discussed earlier (limited data, input space alignment). However, the ML system 102 is significantly more computationally efficient due to the smaller size of the SLM model. There is often a trade-off between model size and performance.

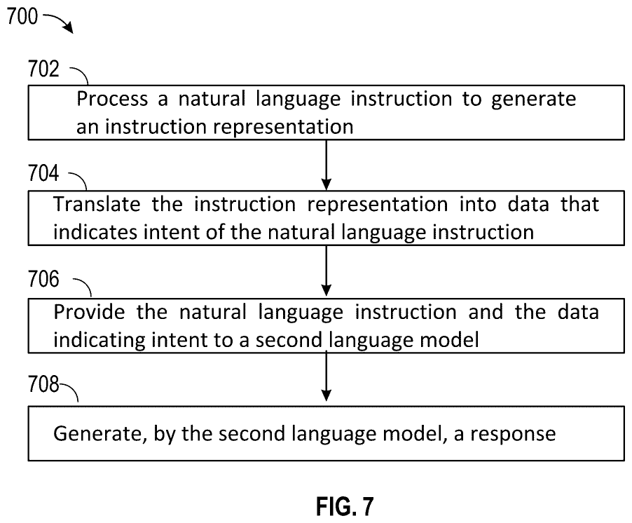

FIG. 7 is a flowchart illustrating an example mode of operation for a machine learning system, according to techniques described in this disclosure. Although described with respect to computing system 200 of FIG. 2 having processing circuitry 243 that executes machine learning system 102, mode of operation 700 may be performed by a computing system with respect to other examples of machine learning systems described herein.

In mode of operation 700, processing circuitry 243 executes machine learning system 102. A first language model (e.g., LLM 112) may process a natural language instruction to generate an instruction representation based on a meaning of the natural language instruction (702). The first language model may analyze the instruction to understand its meaning, considering the context and nuances of the language. In an aspect, the instruction representation may comprise a hidden representation. As used herein, the term “hidden representation” refers to internal activations within a neural network of the first language model. The translation module 114 comprising an interface between the first language model and a second language model (e.g., SLM 116) may translate the instruction representation into data indicating an intent of the natural language instruction (704). The second language model may be trained with domain specific knowledge. In one non-limiting example, the translation module 114 may essentially act as an adapter, ensuring the information from LLM 112 may be represented in a way SLM 116 can effectively utilize for task completion (e.g., code generation). Next, the translation module 114 may provide the natural language instruction and the data indicating the intent of the natural language instruction to the second language model (706). As shown in FIG. 5, the soft prompts 508 generated by the translation module 114 may act as additional context, guiding the second language model towards more relevant code generation, for example. The second language model may generate a response 408 based on the natural language instruction and the data indicating an intent of the natural language instruction (708). In one example, the response 408 may include a sequence of generated tokens 510. In essence, this method combines the strengths of a large language model for understanding natural language with the domain expertise of a smaller language model to produce tailored and accurate responses. By leveraging both models, the ML system 102 may effectively handle a variety of tasks and provide informative answers to user queries.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in computer-readable media, such as a computer-readable storage medium, containing instructions. Instructions embedded or encoded in one or more computer-readable storage mediums may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A method for generating responses by a Machine Learning (ML) system, the method comprising:
processing, by a first language model, a natural language instruction to generate an instruction representation based on a meaning of the natural language instruction;
translating, by a translation module comprising an interface between the first language model and a second language model, the instruction representation into data indicating an intent of the natural language instruction, wherein the second language model is trained with domain specific knowledge;
providing, by the translation module, the natural language instruction and the data indicating the intent of the natural language instruction to the second language model; and
generating, by the second language model, a response based on the natural language instruction and the data indicating the intent of the natural language instruction.

2. The method of claim 1, wherein generating a response comprises:
generating a programming code based on the natural language instruction.

3. The method of claim 2,
wherein the programming code implements a user desired function, and
wherein the natural language instruction specifies an input format and an expected behavior of the user desired function.

4. The method of claim 1, wherein generating the instruction representation further comprises:
generating, by the first language model, a hidden representation indicative of the meaning of the natural language instruction.

5. The method of claim 4, wherein translating, by the translation module, the instruction representation into data indicating an intent of the natural language instruction comprises:
concatenating and/or adding, by the translation module, the hidden representation with one or more prefix embeddings to form the data.

6. The method of claim 4, wherein the translation module comprises a machine learning model, the method further comprising:
training the machine learning model of the translation module to translate the instruction representation into the data indicating the intent of the natural language instruction using a dataset containing pairs of the natural language instructions and corresponding responses.

7. The method of claim 6, further comprising:
at least one of 1) freezing the first language model and the second language model while training the translation module and 2) freezing the first language model while training the translation module and training the second language model.

8. The method of claim 6, wherein the machine learning model comprises a transformer network, a Recurrent Neural Network (RNN) or a state space model.

9. The method of claim 4,
wherein processing the natural language instruction comprises tokenizing the natural language instruction into a sequence of instruction tokens, and
wherein generating the hidden representation comprises generating the hidden representation based on the sequence of instruction tokens.

10. The method of claim 1,
wherein the first language model is a large language model (LLM), and
wherein the second language model is a smaller domain-specific model.

11. A computing system for generating responses by a Machine Learning (ML) system, the computing system comprising:
processing circuitry in communication with storage media, the processing circuitry configured to execute a machine learning system comprising a first language model, a second language model and a translation module, the machine learning system configured to:
process, by the first language model, a natural language instruction to generate an instruction representation based on a meaning of the natural language instruction;
translate, by the translation module comprising an interface between the first language model and the second language model, the instruction representation into data indicating an intent of the natural language instruction, wherein the second language model is trained with domain specific knowledge;
provide, by the translation module, the natural language instruction and the data indicating the intent of the natural language instruction to the second language model; and
generate, by the second language model, a response based on the natural language instruction and the data indicating the intent of the natural language instruction.

12. The system of claim 11, wherein the machine learning system configured to generate the response is further configured to:
generate a programming code based on the natural language instruction.

13. The system of claim 12,
wherein the programming code implements a user desired function, and
wherein the natural language instruction specifies an input format and an expected behavior of the user desired function.

14. The system of claim 11, wherein the machine learning system configured to generate the instruction representation is further configured to:
generate, by the first language model, a hidden representation indicative of the meaning of the natural language instruction.

15. The system of claim 14, wherein the machine learning system configured to translate the instruction representation into the data indicating the intent of the natural language instruction is further configured to:
concatenate and/or add, by the translation module, the hidden representation with one or more prefix embeddings to form the data.

16. The system of claim 14, wherein the translation module comprises a machine learning model, the machine learning system further configured to:
train the machine learning model of the translation module to translate the instruction representation into the data indicating the intent of the natural language instruction using a dataset containing pairs of the natural language instructions and corresponding responses.

17. The system of claim 16, the machine learning system further configured to:
at least one of 1) freeze the first language model and the second language model while training the translation module and 2) freeze the first language model while training the translation module and training the second language model.

18. The system of claim 16, wherein the machine learning model comprises a transformer network, a Recurrent Neural Network (RNN) or a state space model.

19. The system of claim 11,
wherein the first language model is a large language model (LLM), and
wherein the second language model is a smaller domain-specific model.

20. Non-transitory computer-readable storage media having instructions encoded thereon, the instructions configured to cause processing circuitry to:
process, by a first language model, a natural language instruction to generate an instruction representation based on a meaning of the natural language instruction;
translate, by a translation module comprising an interface between the first language model and a second language model, the instruction representation into data indicating an intent of the natural language instruction, wherein the second language model is trained with domain specific knowledge;
provide, by the translation module, the natural language instruction and the data indicating the intent of the natural language instruction to the second language model; and
generate, by the second language model, a response based on the natural language instruction and the data indicating the intent of the natural language instruction.
